(19) United States
(12) Patent Application Publication
(10) Pub. No.: US 2013/0022421 A1
(43) Pub. Date: Jan. 24, 2013

(54) ABRASIVE CORING BIT

(71) Applicants: Jonathan Markwald, Elmhurst, IL (US); Joshua Barhittle, Chicago, IL (US); Timothy Baker, Aurora, IL (US)

(72) Inventors: Jonathan Markwald, Elmhurst, IL (US); Joshua Barhittle, Chicago, IL (US); Timothy Baker, Aurora, IL (US)

(73) Assignees: ROBERT BOSCH GMBH, Stuttgart (DE); ROBERT BOSCH TOOL CORPORATION, Broadview, IL (US)

(21) Appl. No.: 13/188,007

(22) Filed: Jul. 21, 2011

(51) Int. Cl. B23B 51/04; B28D 1/14

(52) U.S. Cl. 408/145; 408/204

(57) ABSTRACT

A coring bit accessory for a rotary tool is provided herein, including a shank for coupling with a rotary tool, a body including a generally cylindrical structure having a proximal end portion defining a leading rim, an abrasive ring bonded to or incorporated into the leading rim, and at least one abrasive strip bonded to or incorporated into the body and extending from the proximal end portion to the distal end of the body.

### FIELD OF THE INVENTION

This invention relates to the field of rotary tool bits and more particularly to bits for hand-held rotary tools.

### BACKGROUND

Hand-held rotary tools are widely used by many people, including professional remodelers, tile installers, homeowners, and artists. These rotary tools typically include an outer housing designed to be easily held within a human hand. The housing retains an electric motor which is operable to drive a rotatable collet or chuck of the rotary tool at high speeds, often at a rate at or above 20,000 revolutions per minute (“rpm”). An accessory may be releasably coupled with the collet thereby enabling the rotary tool to rotatably drive the accessory. The wide variety of accessories that are available for use with hand-held rotary tools provide great versatility due to the wide variety of accessories that may be used therein. Those accessories include cutting bits, cut-off wheels, polishing wheels, grinding wheels, and sanding discs. In addition, accessories specially designed for a particular type of material that is to be cut, drilled, or polished create a versatility and functionality that is not found in other tools.

One such accessory often used with drills, but which may be adaptable for use with a hand-held rotary tool is a core drill bit. A core drill bit is often utilized when cutting ceramics materials, glass, stone, or other hard materials. The core drill has a hollow core with a cylindrical cutting edge or rim surrounding the core, with the exterior of the core defining the size of the hole to be cut by the bit. These bits often include a segmented rim for engaging the hard surface, and typically include a hard abrasive attached to, or incorporated into that rim to further increase the speed of the cutting action. While these coring bits are useful in boring operations such as making a hole through a material, such a bit can only drill a hole of the size of the actual core diameter, requiring a user to purchase multiple sizes of core drill bits to cut multiple sizes of holes, and most bits require the use of a handheld tool that operates at under 15,000 revolutions per minute, and many such bits require the use of a coolant and/or lubricant when in operation.

Further, a typical core drilling bit allows for very little, if any, adjustment of the angle or location of the hole once the bit has entered the workpiece, as the rim is the only cutting surface of the coring bit. Should the bit be improperly tilted when presented to the workpiece, it is extremely difficult to change the orientation of the hole. Further, in the event that an oblong or irregular-shaped opening is needed, additional tools are typically necessary to create a shape other than a circular hole the size of the selected coring bit.

Efforts to address the shortcomings of coring bits for hard surfaces include U.S. Pat. No. 3,848,687 (the “'687 patent”), which includes utilizing Hinders embedded within spiral cut grooves in the exterior surface of the cylinder wall of a hole saw for cutting concrete. In particular, the '687 patent utilizes tungsten carbide Hinders welded to the rim of the holes saw such that those project a predetermined distance “D” from the rim, while Hinders embedded within spiral cut grooves in the exterior surface of the cylinder wall project a smaller distance “d” from the rim, thereby directing chips of concrete displaced at the rim backward toward the shank of the bit. However, manufacture of such a bit requires machining spirals into the exterior of the bit, and incorporating a significant amount of abrasive material into the exterior of the bit cylinder—two features that add greatly to the cost and complexity of manufacturing such a bit. Further, the bit disclosed in the '687 patent does not effectively allow the bit to be used to change the orientation or shape of the hole being bored, as the abrasive Hinders projecting from the exterior of the cylinder do not project as far as the Hinders being used at the rim. Therefore, a cost-effective coring bit that overcomes these deficiencies and is operable to be used in a rotary hand tool would be greatly appreciated.

### SUMMARY

In accordance with at least one embodiment, a coring bit is provided, the coring bit having a shank attached to a distal end portion of a generally cylindrical structure, the generally cylindrical structure having a proximal end portion defining a leading opening. Further provided is a ring of abrasive material positioned on or embedded within the proximal end portion so as to extend around the leading opening, and at least one strip of abrasive material positioned on the generally cylindrical structure, with the at least one strip of abrasive material extending from the proximal end portion to the distal end portion.

In accordance with another embodiment, a second strip of abrasive material is positioned on the generally cylindrical structure, with the second strip extending from the proximal end portion to the distal end portion, and the second strip of abrasive material is spaced apart from the first strip of abrasive material in such a way that a first and second non-abrasive region is defined thereby.

In accordance with another embodiment, the generally cylindrical structure defines a first lateral side opening within the first non-abrasive region and a second lateral side opening within the second non-abrasive region. In accordance with certain embodiments, the generally cylindrical structure is substantially hollow such that it defines a central cavity, and the first and second lateral side openings communicate with the central cavity.

In accordance with an embodiment, the distal portion of the generally cylindrical structure defines a trailing terminal end, with the first strip of abrasive material extending from the proximal end portion to the trailing terminal end. In accordance with certain embodiments, both a first and a second strip of abrasive material extend from the proximal end portion to the training terminal end.

In accordance with at least one embodiment, the generally cylindrical structure defines a longitudinal axis about which the bit rotates during use, and the first strip of abrasive material extends generally parallel to that longitudinal axis. In accordance with another embodiment, both a first strip of abrasive material and a second strip of abrasive material extend generally parallel to the longitudinal axis.

In accordance with at least one embodiment, the proximal end portion of the generally cylindrical structure has both an interior surface and an exterior surface, with the ring of abrasive material positioned on both the interior and exterior surface. In accordance with certain embodiments, the ring of abrasive material and/or first and/or second strips of abrasive material comprise diamond particles.

In accordance with at least one embodiment, the generally cylindrical structure includes an exterior surface, and the ring of abrasive material and the first strip of abrasive material are adhered to an exterior surface by single layer electroplating. In accordance with at least one embodiment, a second strip of abrasive material is adhered to the exterior surface by single layer electroplating.

In accordance with at least one embodiment, the ring of abrasive material, the first and/or second abrasive strips are configured to withstand rotational speeds in excess of 15,000 revolutions per minute. In accordance with at least one embodiment, the ring of abrasive material, the first and/or second abrasive strips are configured to withstand rotational speeds in excess of 25,000 revolutions per minute.

the cylindrical portion and a spherical portion, a nickel based bonding material affixed to the work portion, and a plurality of abrasive particles extending outwardly of the bonding material.

### BRIEF DESCRIPTION OF THE DRAWINGS

FIG. 1 shows a schematic of a coring bit in accordance with the present invention in association with a rotary tool and collet;

FIG. 2 shows a perspective view of a coring bit in accordance with the present application;

FIG. 3a shows a side plan view of the bit of FIG. 1;

FIG. 3b shows a rear plan view of the bit of FIG. 1;

FIG. 4a shows a side plan view of the bit of FIG. 3a, wherein the bit has been rotated approximately 90 degrees along its longitudinal axis when compared to FIG. 3a;

FIG. 4b is a front plan view of the bit of FIG. 4a

FIG. 5a is a side cross-sectional view of the bit of FIG. 2;

FIG. 5b shows a partial cross-sectional view of area b the bit of FIG. 5a, magnified to show area b in greater detail;

FIG. 5c shows a partial cross-sectional view of area c the bit of FIG. 5a, magnified to show area c in greater detail.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

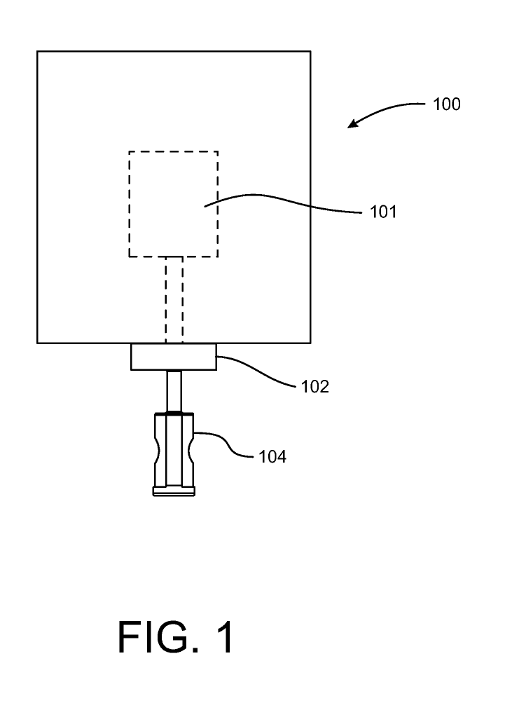

As discussed in further detail in U.S. patent application Ser. No. 12/002,436 to Liu, Jie et al., the contents of which are incorporated by reference in their entirety herein, a rotary tool 100 includes a motor 101 for providing rotational movement to a collet 102, and a bit 104 as displayed in FIG. 1. In operation, bit 104 is releasably coupled to the collet 102. Operation of the motor 101 in the rotary tool 101 rotates the collet 102, causing the bit 104 to rotate.

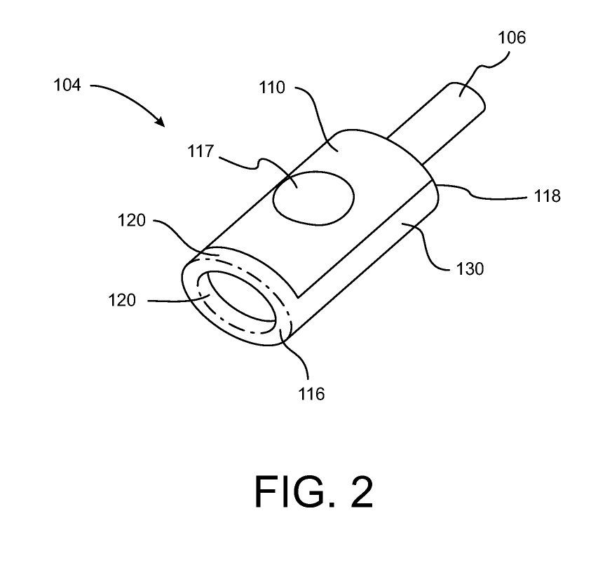

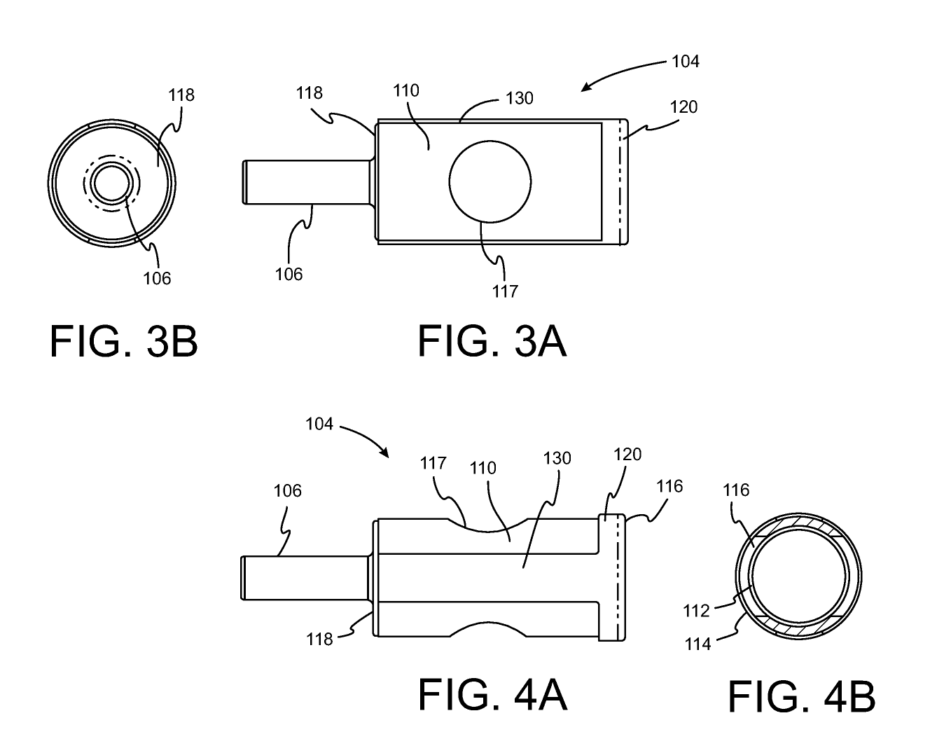

As shown in FIGS. 2, 3a, 3b, 4a, and 4b, bit 104 includes a body portion 110 and a shank portion 106. Shank portion 106 is configured to couple with the collet 102 of a rotary tool 100 at the distal end, and to couple with the bit body 110 at the proximal end. Body 110 is a right-circular hollow cylinder having an inner portion 112 and an outer portion 114. The proximal end of bit body 110 defines a rim 116 operable to address a work surface. The distal end of bit body 110 defines a closed portion 118 configured to couple shaft portion 106 to bit body 110.

Rim 116 comprises an abrasive ring 120 comprising abrasive particles bonded to, or embedded within rim 116. Abrasive ring 120 presents an abrasive surface on both the inner portion 112 and outer portion 114 of bit body 110 at the proximal end of bit body 110.

Bit body 110 further comprises at least one abrasive strip 130 extending parallel to the longitudinal axis of bit body 110. The abrasive strip 130 extends from the proximal end of bit body 110 to the distal end of bit body 110. Further, the at least one abrasive strip 130 extends from abrasive ring 120 distally parallel to the longitudinal axis of bit body 110. Bit body 110 comprises at least two abrasive strips 130 located opposite one another. The at least one abrasive strip 130 has a width approximately 7 mm-12 mm, approximately 8 mm-11 mm, approximately 9 mm-10 mm, or approximately 9.4 mm-9.8 mm.

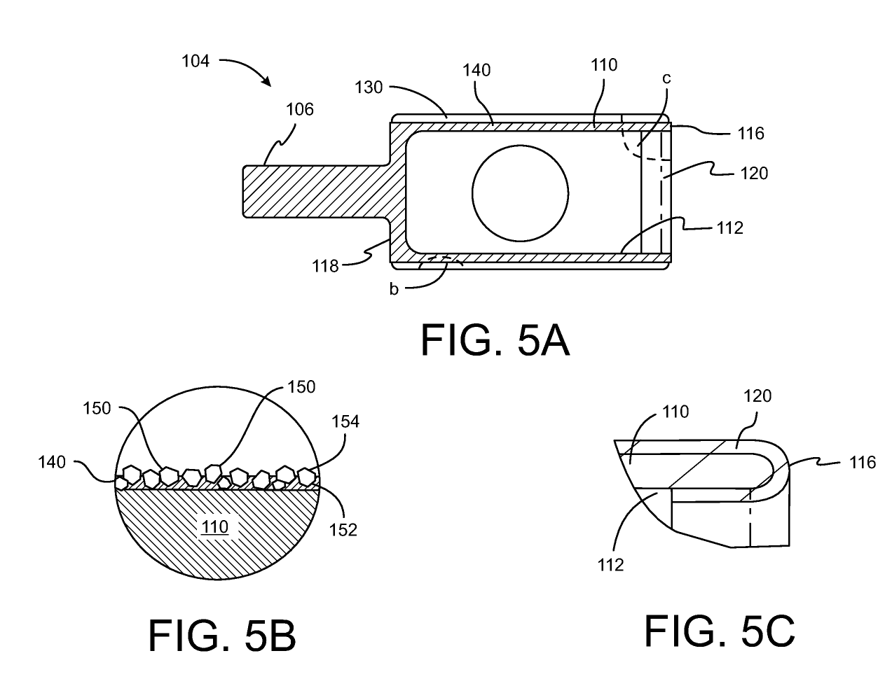

Abrasive ring 120 and/or abrasive strip 130 comprises a bonding material 140 and abrasive particles 150, which is shown more clearly in FIG. 5b. Abrasive particles 150 are partially embedded within bonding material 140 throughout abrasive ring 120 and/or abrasive strip 130. Bonding material 140 attaches abrasive particles 150 to bit body 110 through the process of electroplating, such as single or multiple layer electroplating.

Abrasive particles 150 comprise diamond particles, tungsten carbide particles, titanium carbide particles, tantalum carbide particles, vanadium carbide particles, aluminum oxide particles, silicon dioxide particles, or other particles comprising ceramic alloys or carbide alloys. Abrasive particles have a grit selected from a range of about 20 to 120, a range of about 30-100, a range of about 30-60, or a range of about 30-40. Abrasive particles 150 comprising diamond particles with grit between about 30 and about 40 are well suited for making cuts in hard, brittle material when used on a high speed rotary tool and may be used in the abrasive ring 120 and/or abrasive strip 130.

Abrasive particles 150 comprising abrasive ring and/or abrasive strip 130 include an embedded portion 152 and an exposed portion 154. The amount of bonding material 140 applied to bit body 110 is optionally controlled to generate the desired bonding strength. The amount of bonding material 140 is controlled to generate a protrusion of between about 30 percent and 55 percent for abrasive particles 150 comprising abrasive ring 120 or abrasive strip 130. Thus, most of the abrasive particles 150 will exhibit an exposed portion 154 that is between about 30 percent and 55 percent of the respective abrasive particle 150.

In addition to controlling the amount of bonding material 140, the amount of abrasive particles 150 may be controlled to provide the desired coverage. As shown in FIG. 5b, a magnified view of a portion of bit body 110 and abrasive strip 130, abrasive particles 150 are bonded to the bit 104 at a concentration that results in an average spacing between adjacent abrasive particles 150 of 100 percent or a “full concentration.” Full concentration indicates that the distance between adjacent abrasive particles 150 is approximately equal to the sum of the radii of the two abrasive particles 150.

Bit 104 comprises a metal, such as steel such as AISI 1018 steel. In at least one embodiment, bit 104 comprises steel having an HRb hardness of about 70-90, and optionally comprises a nickel plated finish. According to certain embodiments, bit 104 comprises a bit body opening 117 passing from outer portion 114 to inner portion 112 operable to allow dust from the workpiece to pass between the outside and inside of bit body 110, to aid in extracting of any core pieces held inside the bit after use, and/or to allow the introduction of lubricating fluids during operation.

In operation, shank 106 of bit 104 is attached to the chuck of a rotary tool. Thereafter, rotary tool is operated to spin bit 104, and the rim 116 of bit 104 is presented to a workpiece at approximately a right angle, or at whatever angle a user determines a hole or opening should be made. Rotary tool 100 is operated to spin bit 104 at a rate of approximately more than 15,000 rpm, more than 20,000 rpm, or more than 30,000 rpm. Bit 104 is operable to withstand operation in contact with a workpiece at such speeds. Bit 104 is operated with or without lubricating liquids.

It will be appreciated that bit 104 is utilized to enter into the surface of a workpiece and travel therethrough, creating a hole in the workpiece equal to the diameter of bit body 110. Further, it will be appreciated that the one or more abrasive strips 130 allow a user to apply pressure at an angle to the drilling path, thereby allowing a user to create an elongated hole within the workpiece. Likewise, applying continued pressure at an angle to the drilling path allows a user to effectively cut a line at least as wide as the diameter of the bit body 110, thereby allowing bit 104 to be used both for drilling and reaming of a workpiece.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A bit, comprising:
a body including (i) a generally cylindrical structure having a proximal end portion defining a leading opening and a distal end portion, and (ii) an end structure positioned to close the distal end portion of the generally cylindrical structure;
a shaft attached to said end structure and extending away from said generally cylindrical structure,
a ring of abrasive material positioned on said proximal end portion so as to extend around said leading opening; and
a first strip of abrasive material positioned on said generally cylindrical structure, said first strip of abrasive material extending from said proximal end portion to said distal end portion.

2. The bit of claim 1, further comprising a second strip of abrasive material positioned on said generally cylindrical structure, wherein:
said second strip of abrasive material extends from said proximal end portion to said distal end portion, and
said second strip of abrasive material is spaced apart from said first strip of abrasive material so as to define a first non-abrasive region and a second non-abrasive region of said generally cylindrical structure, each being interposed between said first strip of abrasive material and said second strip of abrasive material.

3. The bit of claim 1, wherein said generally cylindrical structure defines:
a first lateral side opening aligned with said first non-abrasive region, and
a second lateral side opening aligned with said second non-abrasive region.

4. The bit of claim 3, wherein:
said generally cylindrical structure defines a central cavity,
said first lateral side opening communicates with said central cavity, and
said second lateral side opening communicates with said central cavity.

5. The bit of claim 1, wherein:
said distal end portion of said generally cylindrical structure defines a trailing terminal end, and
said first strip of abrasive material extends from said proximal end portion to said trailing terminal end.

6. The bit of claim 2, wherein:
said distal end portion of said generally cylindrical structure defines a trailing terminal end,
said first strip of abrasive material extends from said proximal end portion to said trailing terminal end, and
said second strip of abrasive material extends from said proximal end portion to said trailing terminal end.

7. The bit of claim 1, wherein:
said generally cylindrical structure defines an axis about which said bit rotates during use of said bit,
said first strip of abrasive material extends generally parallel to said axis.

8. The bit of claim 2, wherein:
said generally cylindrical structure defines an axis about which said bit rotates during use of said bit,
said first strip of abrasive material extends generally parallel to said axis, and
said second strip of abrasive material extends generally parallel to said axis.

9. The bit of claim 1, wherein:
said proximal end portion of said generally cylindrical structure includes an interior surface and an exterior surface, and
said ring of abrasive material is positioned on both said interior surface and said exterior surface.

10. The bit of claim 1, wherein:
said ring of abrasive material includes a ring of diamond particles, and
said first strip of abrasive material includes a first strip of diamond particles.

11. The bit of claim 2, wherein:
said ring of abrasive material includes a ring of diamond particles,
said first strip of abrasive material includes a first strip of diamond particles, and
said second strip of abrasive material includes a second strip of diamond particles.

12. The bit of claim 1, wherein:
said generally cylindrical structure includes an exterior surface,
said ring of abrasive material is adhered to said exterior surface by single layer electroplating, and
said first strip of abrasive material is adhered to said exterior surface by single layer electroplating.

13. The bit of claim 2, wherein:
said generally cylindrical structure includes an exterior surface,
said ring of abrasive material is adhered to said exterior surface by single layer electroplating,
said first strip of abrasive material is adhered to said exterior surface by single layer electroplating, and
said second strip of abrasive material is adhered to said exterior surface by single layer electroplating.

14. The bit of claim 1, wherein each of said ring of abrasive material and said first strip of abrasive material is configured to withstand rotational speeds in excess of 15,000 revolutions per minute.

15. The bit of claim 2, wherein each of said ring of abrasive material, said first strip of abrasive material, and said second strip of abrasive material is configured to withstand rotational speeds in excess of 15,000 revolutions per minute.

16. The bit of claim 1, wherein each of said ring of abrasive material and said first strip of abrasive material is configured to withstand rotational speeds in excess of 25,000 revolutions per minute.

17. The bit of claim 2, wherein each of said ring of abrasive material, said first strip of abrasive material, and said second strip of abrasive material is configured to withstand rotational speeds in excess of 25,000 revolutions per minute.

18. The bit of claim 1, wherein said leading opening is a continuous rim.
